(19) United States
(12) Patent Application Publication
(10) Pub. No.: US 2013/0041525 A1
(43) Pub. Date: Feb. 14, 2013

(54) SAFETY DEVICE ELECTRONIC IGNITION INTERLOCK SYSTEM

(71) Applicant: Michael D. Tomberlin, Augusta, GA (US)

(72) Inventor: Michael D. Tomberlin, Augusta, GA (US)

(21) Appl. No.: 13/205,930

(22) Filed: Aug. 9, 2011

(51) Int. Cl. G06F 7/00

(52) U.S. Cl. 701/2

(57) ABSTRACT

A safety device ignition interlock system for a vehicle. The system includes an ignition interlock receiver and controller located on a vehicle and a pairing located on the vehicle operable for pairing the ignition interlock receiver to operate in cooperation with selected ignition interlock transmitters. The ignition interlock receiver and controller is operable for activating an ignition circuit when the ignition interlock transmitter is within an operational distance from an ignition interlock receiver located on a safety device that has been paired with the ignition interlock receiver. By way of examples, the vehicle may be a motorcycle, all-terrain vehicle, off road vehicle, jets ski, powerboat, construction vehicle, forklift, or utility vehicle and the safety device may be a helmet, hard hat, life jacket or high-visibility vest. The system may also include a remote monitoring and control system.

### FIELD OF THE INVENTION

The present invention relates to safety devices for vehicles and, more particularly, relates to an electronic ignition interlock system that includes a transmitter carried by a safety device, such as a helmet or life jacket.

### BACKGROUND OF THE INVENTION

Recreational vehicles, such as motorcycles both on and off road, all-terrain vehicles, other types of off-road vehicles, jet skis, powerboats utility vehicles, construction vehicles, forklifts and other equipment may have a required or recommended safety device such as a helmet, hard hat, life jacket, or high-visibility vest. Accidents involving these vehicles in which the operators are not wearing the safety devices continue to occur at alarming rates. Many of these accidents involve children who are new to the driving experience. Although injuries can often be lessened or eliminated if the operator wears the required or recommended safety device, the operator often fails to wear the safety device. Conventional electronic ignition interlocks are commonplace, but they are not configured to require safety devices to be worn by the vehicle operators. There remains a need for an automatic device to ensure that the operator of a vehicle is wearing an appropriate safety device when operating a vehicle.

### SUMMARY OF THE INVENTION

The present invention meets the needs described above in an ignition interlock system for a vehicle. The system includes an ignition interlock receiver and controller located on a vehicle and a pairing located on the vehicle operable for pairing the ignition interlock receiver to operate in cooperation with selected ignition interlock transmitters. The ignition interlock receiver and controller is operable for activating an ignition circuit when the ignition interlock transmitter is within an operational distance from an ignition interlock receiver located on a safety device that has been paired with the ignition interlock receiver.

The ignition interlock system also includes an ignition interlock transmitter and controller located on the safety device. The ignition interlock receiver and controller typically includes an active or a passive RFID transmitter. The vehicle shuts the ignition off automatically if the safety device becomes out of range. By way of examples, the vehicle may be a motorcycle, all-terrain vehicle, off road vehicle, jets ski, powerboat, construction vehicle, forklift, or utility vehicle and the safety device may be a helmet, hard hat, life jacket or high-visibility vest.

The ignition interlock system may also include a remote system for communicating with the receiver controller on the vehicle. The remote system may be operable for registering the vehicle with identification information for safety devices to be paired with the vehicle. The remote system may also be operable for monitoring the safety device paired with the vehicle.

### BRIEF DESCRIPTION OF THE DRAWINGS

FIG. 1 is a conceptual illustration of a vehicular safety device ignition interlock.

FIG. 2 is an illustration of a helmet including a transmitter for a vehicular safety device ignition interlock.

FIG. 3 is an illustration of the inside of the helmet of FIG. 2 showing the transmitter for the vehicular safety device ignition interlock.

FIG. 4 is an illustration of the receiver for the vehicular safety device ignition interlock located on the vehicle.

### DETAILED DESCRIPTION OF ILLUSTRATIVE EMBODIMENTS

The present invention solves the problems with conventional safety devices by locating the transmitter for an electronic ignition interlock on a safety device. The safety device electronic ignition interlock also includes a pairing lock that provides a secure mechanism for pairing different safety devices with the electronic ignition interlock on the vehicle. The ignition interlock receiver and controller is operable for activating the ignition circuit for the vehicle when the ignition interlock transmitter is within an operational distance from an ignition interlock receiver located on a safety device that has been paired with the ignition interlock receiver. The vehicle shuts the ignition off automatically if the safety device becomes out of range to encourage the operator to wear the safety device properly while operating the vehicle. The safety device interlock also allows different safety devices to be paired with the vehicle.

The safety device interlock has the advantage of requiring that a safety device remain with the vehicle during operation, which is not accomplished by conventional electronic ignition interlocks. The safety device interlock also disables the vehicle when the safety device becomes out of range, and allows different safety devices to be paired with the vehicle, which are additional features not performed by conventional ignition interlocks. By way of examples, the vehicle may be a motorcycle, all-terrain vehicle, off road vehicle, jets ski, powerboat, construction vehicle, forklift, or utility vehicle and the safety device may be a helmet, hard hat, life jacket or high-visibility vest.

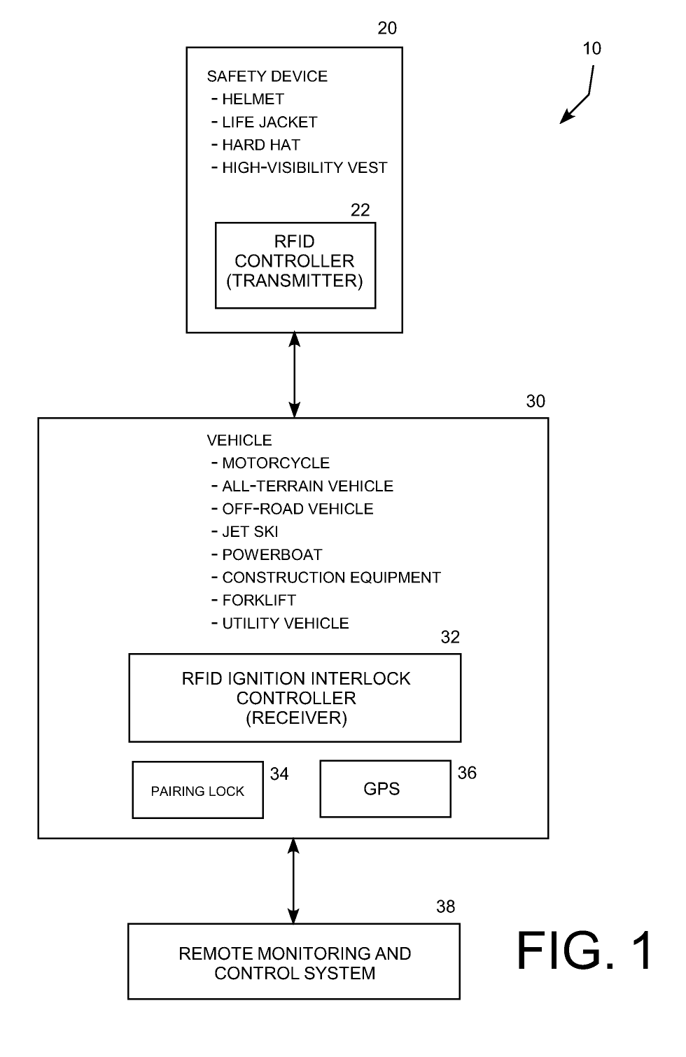

FIG. 1 is a conceptual illustration of a vehicular safety device ignition interlock system 10 for a vehicle 30. In this illustrative example the vehicle is an all-terrain vehicle and the safety device is a helmet. It will be understood that the invention can be readily adapted to other types of vehicles and safety devices. The interlock system includes a transmitter and controller 22 located on the safety device. For example, the transmitter and controller may be an active or a passive RFID transmitter and controller located on a helmet, hard hat, life jacket or other type of safety device. The interlock system also includes a receiver and controller 32 located on the vehicle 30, which may be an active or a passive RFID transmitter and controller. The vehicle also includes a pairing lock 34 that allows different safety devices to be paired with the receiver and controller 32. The pairing lock 34 restricts pairing to a selected type of safety device. For example, a motorcycle can only be paired with a helmet, a jet ski can only be paired with a life jacket, and so forth. In addition, the vehicle can be paired with multiple devices, such as all hard hats issued for use on a construction site or warehouse. The vehicle may optionally include a GPS 38 and remote reporting allowing the vehicle to communicate with a remote monitoring and control system 38.

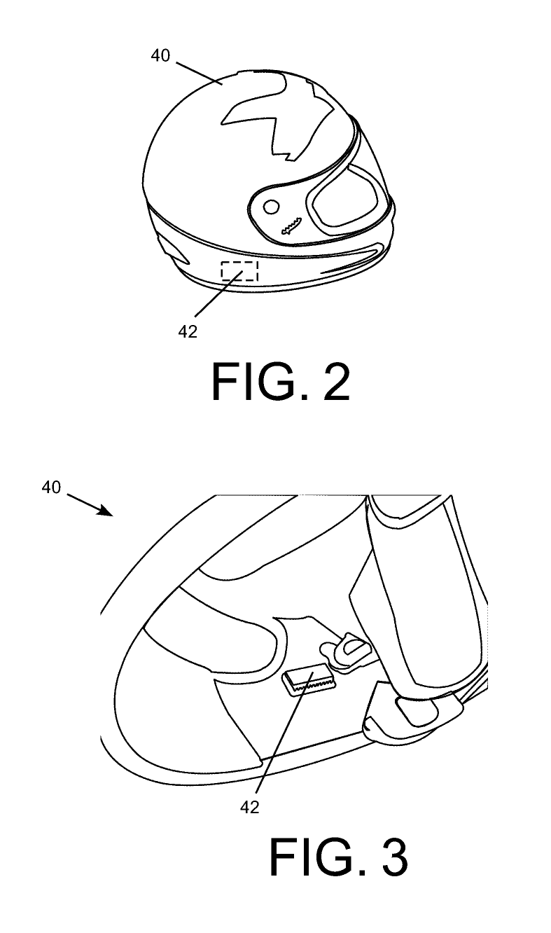

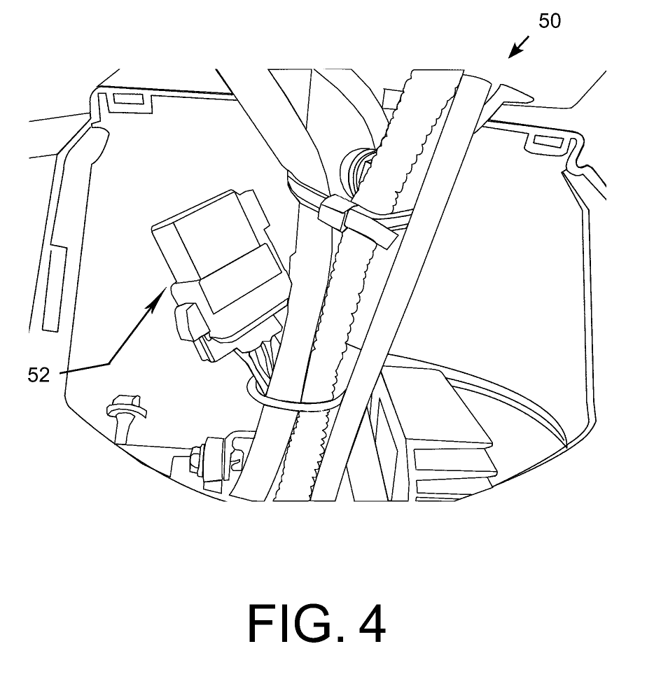

FIG. 2 is an illustration of a helmet 40 including an RFID transmitter 42 for a vehicular safety device ignition interlock. FIG. 3 shows the inside of the helmet from the underside with the padding removed to expose the RFID transmitter. FIG. 4 is an illustration of the receiver controller 52 located in the wiring system 50 of the vehicle. The transmitter, which may be an active or a passive RFID device, is typically located on the inside of the helmet under the padding. The material forming a helmet or hard hat is typically RFID friendly, such as plastic or a fiber composite, which makes the helmet or hard hat suitable for a passive RFID transmitter. The transmitter can be located under an RFID friendly layer of other safety devices. For example, the transmitter can also be sewn in the inside of the outer shell of a life jacket or high-visibility vest. In addition, modern RFID transmitters are water tolerant, which allows them to function even when wet. The RFID transmitter 42 may be conventional except that for this application it includes pairing functionality allowing the transmitter to be selectively paired with a selected transmitter controller. The pairing function preferably utilizes software logic located in the receiver controller to avoid the need for a manual pairing switch on the safety device. However, a pairing switch on the safety device may be employed if desired.

The safety device safety interlock may include a number of options typically implemented through the remote monitoring and control system 38. For example, range setting and safety device registration for pairing can be implemented through a remote computer application. The vehicle (or the safety device) may also include a GPS and reporting functionality allowing the vehicle (or the safety device) to be tracked and indicated on mapping system at the remote system. The safety devices may have unique identifiers allowing the specific safety device paired to a vehicle to be identified, reported and tracked. This may be useful for safety devices assigned to specific authorized users and for implementing secured limited access to the vehicles controlled from a remote location. In this manner, remotely located personnel can have full knowledge of the location and operation of all safety devices and the vehicles to which they are paired, including the ability to determine if the safety interlock has been defeated and a vehicle is in operation without a paired safety device or if the vehicle is under operation at an unauthorized location or time. In this case, the location of the vehicle can be tracked and the ignition interlock can be remotely activated to disable the vehicle if desired. For example, parental controls or site controls including equipment access and monitoring or may be implemented through the remote system.

The invention claimed is:

1. An ignition interlock system for a vehicle, comprising:
an ignition interlock receiver and controller located on a vehicle;
a pairing located on the vehicle operable for pairing the ignition interlock receiver to operate in cooperation with selected ignition interlock transmitters;
wherein the ignition interlock receiver and controller is operable for activating an ignition circuit when the ignition interlock transmitter is within an operational distance from an ignition interlock receiver located on a safety device that has been paired with the ignition interlock receiver.

2. The ignition interlock system of claim 1, further comprising an ignition interlock transmitter and controller located on a safety device.

3. The ignition interlock system of claim 1, wherein the ignition interlock receiver and controller comprises a passive RFID transmitter.

4. The ignition interlock system of claim 1, wherein the ignition interlock receiver and controller comprises an active RFID transmitter.

5. The ignition interlock system of claim 1, wherein the receiver and controller shuts the vehicle ignition off automatically if the safety device becomes out of range.

6. The ignition interlock system of claim 2, wherein the safety device comprises a helmet.

7. The ignition interlock system of claim 2, wherein the safety device comprises a life jacket.

8. The ignition interlock system of claim 2, wherein the safety device comprises a hard hat.

9. The ignition interlock system of claim 2, wherein the safety device comprises a high-visibility vest.

10. The ignition interlock system of claim 2, further a remote system for communicating with the receiver controller on the vehicle.

11. The ignition interlock system of claim 10, wherein the remote system is operable for registering the vehicle with identification information for safety devices to be paired with the vehicle.

12. The ignition interlock system of claim 10, wherein the remote system is operable for monitoring the safety device paired with the vehicle.
